(19) United States
(12) Patent Application Publication
(10) Pub. No.: US 2003/0212574 A1
(43) Pub. Date: Nov. 13, 2003

(54) System and method for online personalized veterinary advice for pets

(76) Inventor: Pierre D. Olivier, Berkeley, CA (US)

Correspondence Address: Pierre Olivier, 933 Hilldale Ave, Berkeley, CA, 94708, US

(21) Appl. No.: 10/139,910

(22) Filed: May 8, 2002

(51) Int. Cl. G06F 17/60; G06F 7/00; G06F 17/00

(52) U.S. Cl. 705/2; 707/104.1; 119/174

(57) ABSTRACT

A system and method for creating and delivering personalized veterinary advice for pets over the web. The invention provides a service to pet owner, which fills the gap between information & advice provided in a book, and the information & advice delivered during a visit to a veterinarian. The method includes retrieving Pet owner's data and the question relating to their pets on the web site, and semi-automatically matching the questions with 3 data bases, which are:

the answer database, pre developed by veterinarians and also refreshed on a on going basis, as soon as new questions arise from other pet owners

the products data base related to the veterinary advice, in case a product is needed

the veterinarian data base, in case of a visit need to be recommended.

Once the matching is completed a customized advice—response is developed. The method includes reviewing of the advice by a veterinary, publishing the answer back to the web site, informing the pet owner that his answer is ready and updating he customer profile with the new set of information, including the debit of his account for the service delivered.

### BACKGROUND

1. Field of the Invention

The present invention relates in general to the veterinary industry and the web industry. More particularly, the present invention relates to a new service, which delivers to Pet owners, personalized veterinary advice's for their Pets (dogs and Cats)

2. Description of the Background Art

People, who have pet(s) do have only 2 ways to get veterinary information or advice's, when their pets are facing health and behavioral issues. Either they read books, which give them too generic a description or they can bring their Pets to their veterinary, which will cost them a lot of time and money.

Because of the cost and time management constraint, Pet owners are only visiting their veterinarian, when the issue is very serious and the life of the pet is at risk. Otherwise they limit themselves to one veterinarian visit per year.

There is a gap between the highly personalized and expensive in person visit to the veterinary and the low-cost but too generic and often irrelevant content from books. Because of this gap, a complete scope of expectation from pet owner is not covered, today.

According to a survey, done by KPMG for the American Veterinary Medical association in April 1999, the scope of expectations from Pet owners covers:

Alternatives to expensive veterinarian visit

preemptive health care

information on hygienic, food, reproduction

information and advice for behavior troubles

The invention is a combination of web-site, data base and semi-automated matching engine.

The core foundation of the invention is the combination of web/data base technology with the creation of veterinary advice by professional veterinarian. The invention operates in the following manner.

Pet's owners are posting their questions on a web site. Within 12 hrs, they received a personalized answer. The personalized answers content the answer to the question, a recommended product, when appropriate, and the name of the most relevant veterinary, in case an in person visit is recommended. The veterinarian or veterinarian assistant develops, with a semi-automatic process, an answer, which includes the right contents (veterinarian answer, product recommendation, need for a visit). The semi-automatic process is a combination of decision trees, which classify each type of answer module, and automated search based on key words. A veterinary will review the prepared answer, before sending it or publishing it back to the web site. It is expected that the “80-20% rule” will apply. As a result and despite each pet is unique, the questions, pet's owners are asking, will be similar. It allows the usage of mass-personalization database engine and the re-use of high value content developed by veterinarians.

The invention, by combining the new technology web-based personalization techniques with the highly skill knowledge of veterinarian, opens a new field of affordable veterinary services, expected and not yet provided to Pet owners.

### SUMMARY

The present invention relates to a system and method for providing personalized veterinary advice for Pets over the web. The scope of advice is:

Concrete advice or information specific to one pet (gender, age, size, location, lifestyle, health track record, . . . )

Behavioral, Alimentation, Hygienic, Reproduction questions

On-going and preemptive care questions and advice

Referral to the relevant products

Referral to the relevant veterinary, if a visit is required

The owner of a Pet submits his question and key information for the pet, to a web site.

Veterinarians have developed a database of answers.

The veterinarian assistants, using the database engine, query the appropriate answer and prepare a customized answer (using key words matching engine).

A veterinarian reviews and validates the proposed answer (if this is a new case, he develops the relevant answer, which will then populate the database)

The answer is sent back to the pet owner, while his-her account is debited for the service provided.

### DETAILED DESCRIPTION

Deficiencies in Prior Systems and Methods

One prior way is for pet's owners to get information themselves. The main sources are books or web sites. The drawback to this method is the lack of relevancy. Each animal is unique and is facing different challenges at each stage of his life. While books are excellent at provide the fundamentals (who to purchase a pet from, how to choose it, how long will it live, . . . ), they reach their limits, as soon as the preventive and personalized cares are required.

The situation with web-sites is worth, since they only focus on selling food or care product. The limitation of current web sites is the absence of a matching process, between a Pet's specific question and a personalized answer.

There is also no linkage with a referral process to help Pet owner find the most relevant veterinarian, in case a visit is required. In short, current web sites are just an extension of a shop, an the Pet owner experience is not managed in a integrated way.

Another prior way is for pet owner to visit a veterinarian. Veterinarian's visits are excellent to cover the upper-end of pet's owner service needs. As soon the health of the pet is at risk, the pet owner is ready to carry the burden of a veterinary visit. The burden components are the price (at least $100 per visit), the time constraint (scheduling an appointment, pick-up the pet at home and bring it the veterinary), the lack of flexibility (waiting time, working hours). As a result, Pet owners don't go to a veterinarian for anything, which is:

“not serious enough”

related to the behavior of the animal (“we can live with it, anyway it is not sick”)

related to preemptive care (“let fix it during the yearly visit or only if the situation get worse).

As a summary, there is a set of expectations and services, which are not covered. Pet owners have the choice between “nothing (ie too generic books) and everything (ie expensive veterinary visit)”. The invention will respond to a full set of Pet owner expectation by offering:

1—a online place where self-service and personalized information can be found

2—a online place where preemptive care can be delivered

3—a online place where behavioral issues for Pet will be covered

4—a online place where pet owner will get the early confirmation, they must visit their veterinary, even if this seems not yet serious enough

The range of benefit from this invention is large and is benefiting the Pet owners, the Pets and the community:

1—Pet will be benefit from regular and preemptive treatment. Better treated through personalized and more frequent follow up (a web personalized, will cost at least ⅕ of the price of a regular veterinary visit, giving the pet owner the flexibility and affordability to have customized advice for its animal)

2—Pet owners will have a cost-effective way to address pet's behavioral issues. The behavioral issues will be treated. For the majority, they are currently left as is, creating stress and inconvenience for pet owner. In the worse case, this push some of them to abandon their pets

3—Reduction of the overall cost for the community. The preemptive care will expand, resulting is cost saving for the community. The community will also benefit from a better gradation and relevancy of services for pets: books, personalized advice through the web offered by veterinarian, in person visit to the relevant veterinarian.

As use herein, the invention related to any type of pets:

dog, cats, reptile, birds, ferrets, rabbits, . . .

List of Specific Embodiments of the Invention

The invention has 7 major components:

1—a web site, where pets owner place their questions, manage their profile and get their personalized answer

2—a data base, with the owner/pet profile information

3—a data base, with the answer modules

4—a data base, with the recommended veterinarian

5—a data base, with the recommended products, related to the answer modules

6—a matching process (classification tree of answering modules and key word search) which prepare the customized answers and submit them to veterinarian for approval before

7—a billing engine, which manage the account of each customer

What is claimed is:

1. A system for providing personalized veterinary advice over the web, the system comprising:
a—customer data base, which include all the profile information related to the pet
b—answer data base, which is populated with predefined answer. The answers are either re-use from previous similar cases (majority over time) or created by the veterinarian approval team.
c—product database, which classifies product related to the veterinary advice
d—veterinary database, which classifies veterinary by location and specialty and is used when a visit to a veterinarian is recommended
e—an answer/response matching engine, including the reviewing by a qualified veterinarian step, before publishing the advice on the web or sending a personalized email
f—a billing engine, which manage the account profile of the customers
